(19) United States
(12) Patent Application Publication
(10) Pub. No.: US 2010/0209545 A1
(43) Pub. Date: Aug. 19, 2010

(54) APPARATUS FOR RELEASING FOOD SLURRY ALONG PREDETERMINED COURSE

(76) Inventor: Ou-Young Robert, Chung-Ho City (TW)

Correspondence Address: Guice Patents PLLC, 12647 Galveston Court #302, Manassas, VA, 20112, US

(21) Appl. No.: 12/388,018

(22) Filed: Feb. 18, 2009

(51) Int. Cl. A23P 1/12

(52) U.S. Cl. 425/113

(57) ABSTRACT

A mechanical apparatus for releasing food slurry along a predetermined path or course is provided. Therein, a slurry extruding mechanism is fixedly provided on a transverse translation frame and a longitudinal translation frame that are powered respectively by servomotors. When the translation frames are simultaneously driven, the food slurry is released from the extruding mechanism onto a conveyor belt along the predetermined course, thereby forming food products of a specific shape.

### BACKGROUND OF THE INVENTION

1. Technical Field

The present invention relates to an apparatus for releasing food slurry. More particularly, the present invention relates to a mechanical apparatus for releasing food slurry along a predetermined course, wherein a slurry extruding mechanism is fixedly provided on a transverse translation frame and a longitudinal translation frame powered respectively by servomotors so as to release the food slurry from the extruding mechanism along the predetermined course.

2. Description of Related Art

Generally, processed food can be formed by hand, by molding and rolling, and by extruding. To form by hand, a solidified dough or material is manually and skillfully kneaded to shape, as is the case with, for example, bread, cakes, dumplings, particularly shaped pastry, and so on. To form by molding and rolling, a mold with cavities of fixed shapes is rolled over or pressed onto a dough, or filled with a slurry to be solidified in the mold cavities, so as to form, for example, cookies, waffles, dumplings, chocolate, and so on. To form by extruding, a semi-solid slurry to be formed is loaded into a hopper and then pushed through extruding nozzles of various shapes by a screw rod, thus extruding out products of desired shapes.

The pros and cons of the foresaid three food processing methods are as follows. Forming by hand allows the rendering of shapes according to personal preferences or needs but is disadvantaged by low production capacity. Forming by molds, though capable of high production capacity, has the drawback of uniform and unvaried product shapes, unless multiple machines are used, or the molds are continuously changed. Forming by extruding is also low in production capacity and only yields strip-like or chunky products having the same pattern or shape as defined by the extruding nozzle, unless the extruding pump is manually controlled to produce a desired shape, such as when making cake decorations or forming specific figures or words in a painting or writing manner.

Herein, food slurry refers to any edible fluid material or edible plastic material, such as chocolate paste, thick syrup, butter, whipped cream, solutions of edible pigments, and dough with or without cereals or spice powders. The food slurry may contain a single ingredient or a mixture of several ingredients.

### BRIEF SUMMARY OF THE INVENTION

It can be known from the above that pastry making by mechanically extruding food slurry is characterized by continuous and unlimited release of food slurry and the use of extruding nozzles to form a variety of shapes with different dimensions. If it is desired to make pastry of an irregularly spiral shape or food products of specific patterns or word-shapes, the traditional manual or molding techniques are not up to the task.

Therefore, the inventor of the present invention proposes an apparatus for releasing food slurry along a predetermined course as disclosed herein. The proposed solution includes a food slurry extruding mechanism fixedly provided on a frame. The food slurry extruding mechanism includes a hopper for containing the food slurry to be extruded, a servomotor, a feeding cylinder, a pushing screw rod, a regulating valve, at least one extruding nozzle, and a controller. The extruding nozzle is extended by a flexible hose and fixed on a transverse translation frame and a longitudinal translation frame powered respectively by servomotors. By driving the translation frames simultaneously and using the extruding mechanism to control the start and stop of a slurry-extruding operation, the food slurry is released from the extruding mechanism onto a conveyor belt along the predetermined course so as to form food products of a specific shape.

### BRIEF DESCRIPTION OF THE SEVERAL VIEWS OF THE DRAWINGS

The invention as well as a preferred mode of use, further objectives, and advantages thereof will be best understood by referring to the following detailed description of an illustrative embodiment in conjunction with the accompanying drawings, wherein:

FIG. 1 is a perspective view of an apparatus for releasing food slurry along a predetermined course according to the present invention;

FIG. 2 is a perspective view of an embodiment of the present invention equipped with a conveyor belt; and

FIG. 3 is a perspective view showing main structures of a transverse translation frame and a longitudinal translation frame according to the present invention.

### DETAILED DESCRIPTION OF THE INVENTION

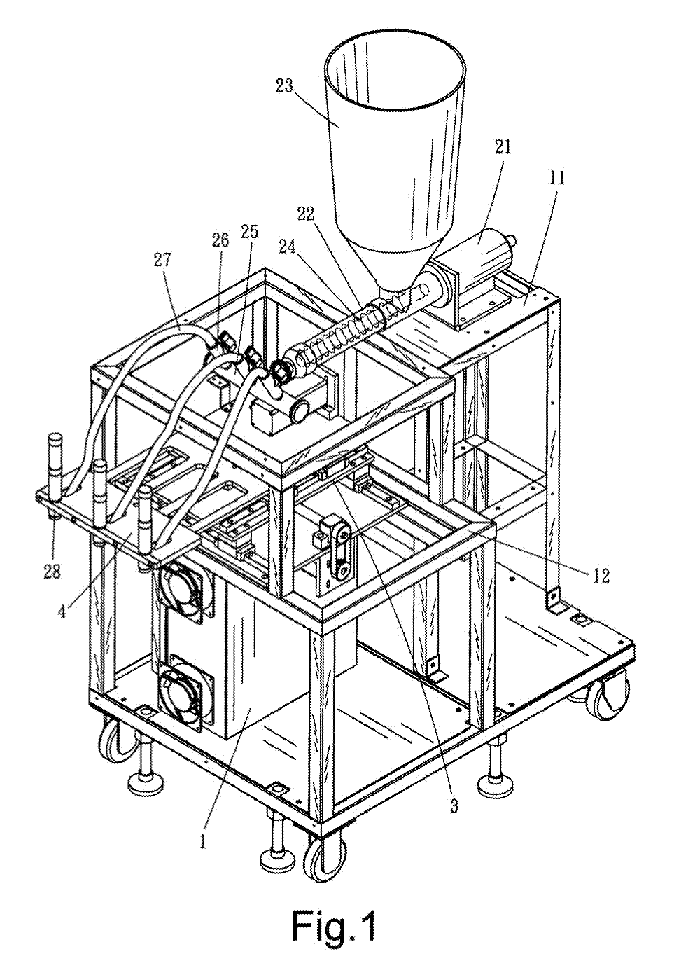

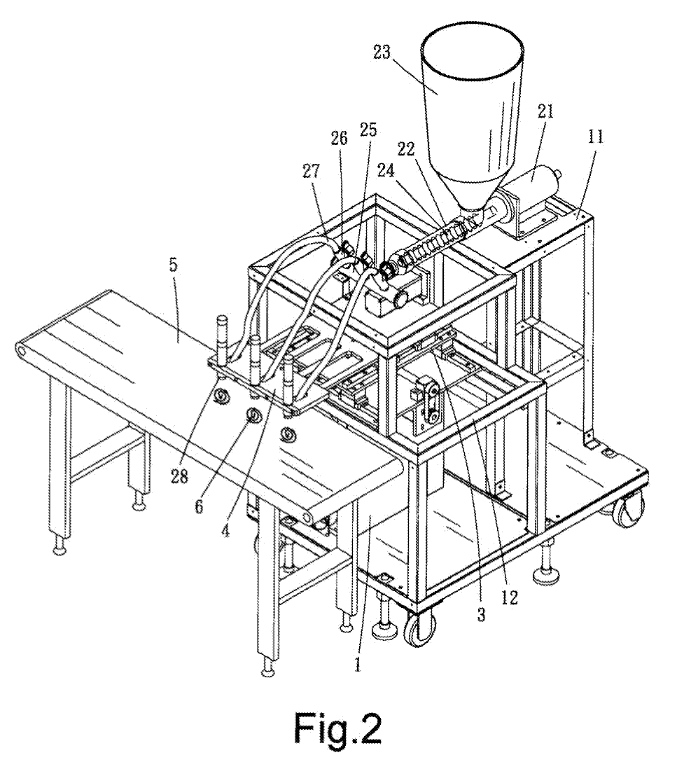

Referring to FIGS. 1 and 2, an apparatus for releasing food slurry along a predetermined course according to the present invention includes a control box 1, a food slurry extruding mechanism provided on an upper frame 11, and a transverse and longitudinal translation mechanism provided on a lower frame 12.

The extruding mechanism is fixedly provided with a servomotor 21. The servomotor 21 has an end coupled with a feeding cylinder 22. The feeding cylinder 22 is in communication with a bottom of a hopper 23 configured for containing the food slurry to be extruded. A pushing screw rod 24 provided in the feeding cylinder 22 has an end coupled with the servomotor 21 and is driven by the servomotor 21 so as to push the food slurry forward. Activation and deactivation of the servomotor 21 are set by a control circuit of the control box 1.

The feeding cylinder 22 has a front end coupled with a regulating valve 25. The regulating valve 25 is provided with one or more diversion pipes 26 each communicating with a flexible hose 27. Each flexible hose 27 has an end coupled with and thus extended by an extruding nozzle 28. The extruding nozzles 28 correspond to the diversion pipes 26 in quantity.

The transverse and longitudinal translation mechanism located on the lower frame 12 corresponds in position to a bottom of the food slurry extruding mechanism. The transverse and longitudinal translation mechanism is provided with a transverse translation frame 3 and a longitudinal translation frame 4 linked vertically together. The transverse translation frame 3 is provided with a servomotor 31 for driving a screw rod 33 via a chain 32 so that the transverse translation frame 3 moves transversely on slide blocks 34 provided under the transverse translation frame 3 and sliding along slide rails 36 fixedly provided on a support plate 35. In addition, the transverse translation frame 3 is provided bilaterally thereon with slide rails 37.

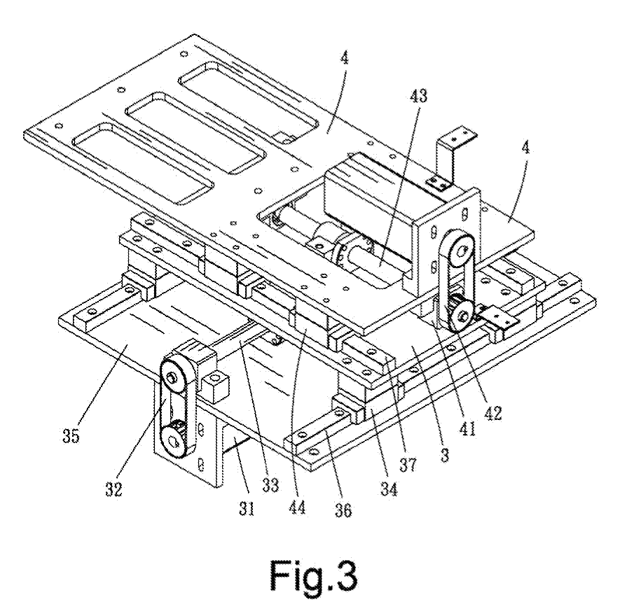

Referring to FIG. 3, the longitudinal translation frame 4 is similarly provided with a servomotor 41, which drives a screw rod 43 via a chain 42 so that the longitudinal translation frame 4 moves longitudinally on slide blocks 44 provided under the longitudinal translation frame 4 and sliding along the slide rails 37 on the transverse translation frame 3.

Activation and deactivation of the servomotors 31 and 41 for respectively driving the transverse translation frame 3 and the longitudinal translation frame 4 are also set by the control circuit of the control box 1.

The extruding nozzles 28 are fixed at a front edge of the longitudinal translation frame 4. Therefore, when the transverse translation frame 3 and the longitudinal translation frame 4 are driven respectively by the servomotors 31 and 41 and are thus simultaneously moved in a transverse direction and a longitudinal direction, respectively, the extruding nozzles 28 are moved along a predetermined course set by the control box 1. In consequence, food products are extruded out along the predetermined course and formed into a predetermined geometry, pattern, or word-shape.

Hence, when the transverse translation frame 3 and the longitudinal translation frame 4 are simultaneously driven for a predetermined period of time, and the servomotor 21 behind the feeding cylinder 22 is rotated to drive the pushing screw rod 24 in the feeding cylinder 22, the food slurry to be extruded is released through the regulating valve 25, the diversion pipes 26, the flexible hoses 27, and finally the extruding nozzles 28 and follows the predetermined course so as to form food products 6 having the predetermined geometry, pattern or word-shape. The food products 6 are dropped onto a tray or conveyor belt 5 under the extruding nozzles 28, as shown in FIG. 2, which shows an embodiment of the present invention equipped with the conveyor belt 5.

Activation, deactivation, and speed of the aforesaid three servomotors 21, 31, and 41 are selected by built-in commands of the control box 1 or set as needed by inputting related data.

1. An apparatus for releasing food slurry along a predetermined course, comprising a control box, a food slurry extruding mechanism provided on an upper frame, and a transverse and longitudinal translation mechanism provided on a lower frame;
wherein the food slurry extruding mechanism comprises a regulating valve provided with at least a diversion pipe in communication with a flexible hose having an end coupled with and thus extended by an extruding nozzle, the extruding nozzle corresponding to the diversion pipe in quantity;
wherein the transverse and longitudinal translation mechanism provided on the lower frame corresponds in position to a bottom of the food slurry extruding mechanism and is provided with a transverse translation frame and a longitudinal translation frame linked vertically together; and
wherein the extruding nozzle is fixed on the longitudinal translation frame such that, when the transverse translation frame and the longitudinal translation frame are simultaneously moved in a transverse direction and a longitudinal direction, respectively, the extruding nozzle is moved along the predetermined course so as to extrude out, along the predetermined course, food products which have a predetermined geometry, pattern, or word-shape and are dropped onto a tray or conveyor belt under the extruding nozzle.

2. The apparatus for releasing food slurry along a predetermined course as claimed in claim 1, wherein the food slurry extruding mechanism comprises a first servomotor having an end coupled with a feeding cylinder in communication with a bottom of a hopper configured for containing the food slurry to be extruded, and a pushing screw rod provided in the feeding cylinder has an end coupled with the first servomotor and is driven thereby so as to push the food slurry forward, activation and deactivation of the first servomotor being set by a control circuit of the control box.

3. The apparatus for releasing food slurry along a predetermined course as claimed in claim 1, wherein the transverse translation frame of the transverse and longitudinal translation mechanism is provided with a second servomotor for driving a first screw rod via a first chain so that the transverse translation frame moves transversely on first slide blocks provided under the transverse translation frame and sliding along first slide rails fixedly provided on a support plate, the transverse translation frame being provided bilaterally thereon with second slide rails; and the longitudinal translation frame is provided with a third servomotor for driving a second screw rod via a second chain so that the longitudinal translation frame moves longitudinally on second slide blocks provided under the longitudinal translation frame and sliding along the second slide rails on the transverse translation frame, activation and deactivation of the first servomotor of the transverse translation frame and activation and deactivation of the second servomotor of the longitudinal translation frame being set by a control circuit of the control box.

4. The apparatus for releasing food slurry along a predetermined course as claimed in claim 2, wherein the activation, the deactivation, and a speed of the first servomotor of the food slurry extruding mechanism are selected by built-in commands of the control box or set as needed by inputting related data.

5. The apparatus for releasing food slurry along a predetermined course as claimed in claim 3, wherein the activation, the deactivation, and a speed of the second servomotor of the transverse translation frame, and the deactivation, the deactivation, and a speed of the third servomotor of the longitudinal translation frame are selected by built-in commands of the control box or set as needed by inputting related data.
